(19) United States
(12) Patent Application Publication
(10) Pub. No.: US 2011/0159316 A1
(43) Pub. Date: Jun. 30, 2011

(54) MAGNETORESISTIVE DEVICE WITH PERPENDICULAR MAGNETIZATION

(75) Inventors: Yung-Hung Wang, Hsinchu County (TW); Cheng-Tyng Yen, Kaohsiung City (TW); Shan-Yi Yang, Hsinchu City (TW)

(73) Assignee: INDUSTRIAL TECHNOLOGY RESEARCH INSTITUTE, Hsinchu (TW)

(21) Appl. No.: 12/713,193

(22) Filed: Feb. 26, 2010

(30) Foreign Application Priority Data
Dec. 31, 2009 (TW) 98146384

(51) Int. Cl. G11B 5/33

(52) U.S. Cl. 428/800

(57) ABSTRACT

A magnetoresistive device with perpendicular magnetization includes a magnetic reference layer, a first magnetic multi-layer film, a tunneling barrier layer, a second magnetic multi-layer film, and a magnetic free layer. The magnetic reference layer has a first magnetization direction, perpendicular to the magnetic reference layer. The first magnetic multi-layer film, having non-magnetic material layer, is disposed in contact on the magnetic reference layer. The tunneling barrier layer is disposed in contact on the first magnetic multi-layer film. The second magnetic multi-layer film, having non-magnetic material layer, is disposed in contact on the tunneling barrier layer. The magnetic free layer is disposed in contact on the second magnetic multi-layer film, having a second magnetization direction capable of being switched to be parallel or anti-parallel to the first magnetization direction.

### CROSS-REFERENCE TO RELATED APPLICATION

This application claims the priority benefit of Taiwan application serial no. 98146384, filed Dec. 31, 2009. The entirety of the above-mentioned patent application is hereby incorporated by reference herein and made a part of specification.

### TECHNICAL FIELD

The disclosure relates to magnetoresistive device with perpendicular magnetization.

### BACKGROUND

For the structure of magnetic random access memory (MRAM), it usually uses the IMA (in-plane magnetic anisotropic) material, also called in-plane magnetization material, as the magnetic layer of a magnetic tunneling junction (MTJ) structure. The IMA material in an example can be Co, Fe, CoFe, NiFe or CoFeB. Based on the mechanism of spin torque transfer (STT), a STT MRAM is taken as an example in consideration. The most challenging issue to realize STT-MRAM with IMA films is to reduce the critical writing current (I_{C}) or current density (J_{C}) to match up the available current of CMOS transistor while maintaining the thermal stability of 10 years reliability. This issue will be more serious when the technology node keeps scaling down, unless characteristics of the magnetic material can have breakthrough.

In addition, the perpendicular magnetic anisotropy (PMA) material, also called perpendicular magnetic material, can very possibly take the place of the STT device with IMA material. Currently developed PMA materials include: (1) rare-earth transition metal (RE-TM) alloys such as TbFeCo and GdFeCo; (2) multi-layer with interfacial perpendicular anisotropy such as Co/Ni and Co/Pt multi-layers; and (3) L1₀ crystalline ordered alloys such as FePt and CoPt. For anyone of the PMA materials, when the PMA material is used in the MTJ structure with MgO as the tunneling barrier layer, called MgO-MTJ, it usually has an issue that the magnetoresistive (MR) ratio is much lower than that of the in-plane MTJ. The reasons are that the MgO-MTJ needs to satisfy two conditions to get high MR ratio by: (1) MgO has to be (001) orientation; and (2) the adjacent ferromagnetic (FM) layer needs to be bcc structure with (001) orientation. If the PMA material is directly stacked with the MgO, it apparently cannot satisfy the conditions to have high MR ratio. Conventionally, it needs an inserted layer between the PMA material and the MgO to provide the proper interface.

FIG. 1 is a cross-sectional view, schematically illustrating a conventional structure of in-plane magnetoresistive device. In FIG. 1, a structure of the in-plane magnetoresistive device includes a magnetic reference layer 100 has a fixed magnetization direction 102 without change by the external magnetic field. The magnetization direction 102 is used as a reference. A tunneling barrier layer 104 is formed on the reference layer 100. A magnetic free layer 106 is disposed on the tunneling barrier layer 104. The magnetic free layer 106 has a magnetization direction 108, which can be switch in direction. The magnetization direction 108 of the magnetic free layer 106 can be freely changed by applying external magnetic field to be parallel or anti-parallel to the magnetization direction 102. By measuring the magnetoresistance differences for the situations of being parallel or anti-parallel between the magnetic free layer 106 and the reference layer 100, the stored binary data in the magnetic free layer 106 can be judged out.

FIGS. 2A-2B are cross-sectional views, schematically illustrating the structures of perpendicular magnetoresistive device. In FIG. 2A, the structure of perpendicular magnetoresistive device basically is formed by a stack of magnetic reference layer 110, a tunneling barrier layer 112, and a magnetic free layer 114. The magnetic reference layer 110 has a magnetization direction 120 at a fixed direction and perpendicular to the horizontal plane. The magnetization direction 122 of the magnetic free layer 114 can be freely switched at two directions and is also perpendicular to the horizontal plane.

However, for the structure of in-plane magnetoresistive device in FIG. 1, if the PMA material is directly used to replace the IMA material to form the perpendicular magnetoresistive device as shown in FIG. 2A, it has an incorrect crystal structure and orientation with respect to the MgO as the tunneling barrier layer 112, resulting in the small MR ratio.

Therefore, it needs a proper inserted layer between the PMA material layer and the MgO tunneling barrier layer 112, so as to increase the MR ratio for the perpendicular magnetoresistive device. In FIG. 2B, another structure of perpendicular magnetoresistive device is based on the structure in FIG. 2A by adding the inserted layer 116 and 118 between the PMA magnetic layer and the MgO tunneling barrier layer 112. The magnetization directions of the inserted layers 116 and 118 also need to be perpendicularly magnetized.

FIG. 3 is a cross-section view, schematically illustrating the reason for the in-plane MgO-MTJ with high MR, based on the magnetic layer of CoFeB. In FIG. 3, taking the MgO as the base for the tunneling barrier layer 132, the crystal orientation is (001). The conventional magnetic layers 130 and 134 are the CoFeB in amorphous (A) structure. After annealing process 136, the amorphous CoFeB is changed to the crystal structure in bcc (001) as the magnetic layers 130′ and 134′. The structure satisfies the condition for the MgO-MTJ with high MR.

FIG. 4 is a cross-section view, schematically the method to form illustrating perpendicular magnetoresistive device by taking CoFeB as the inserted layer. The inserted layer is to increase the MR. In FIG. 4, by the manner in FIG. 3 and taking the structure in FIG. 2 as the base, the inserted layers 116 and 118 are A-CoFeB material. After annealing 136, the inserted layers 116′ and 118′ in the conventional perpendicular magnetoresistive device have the crystal structure of bcc (001). However, for the perpendicular magnetoresistive device, the CoFeB is still the in-plane magnetization material and its magnetization direction is tending to be lying on the film plane. It needs the coupling force between the adjacent PMA film, so as to change the magnetization direction into the perpendicular direction with coupling effect. However, CoFeB has a large amount in saturation magnetization, apparently causing the demagnetic effect. When the demagnetic effect is stronger than the coupling force between the adjacent PMA film, the inserted CoFeB would return back to the magnetization alignment state at in-plane direction, and then the device would be lost in perpendicular STT switching effect.

### SUMMARY

One of embodiments provides a perpendicular magnetoresistive device, which includes a magnetic reference layer, a first magnetic multi-layer film, a tunneling barrier layer, a second magnetic multi-layer film, and a magnetic free layer. The magnetic reference layer has a first magnetization direction, perpendicular to the magnetic reference layer. The first magnetic multi-layer film, having non-magnetic material layer, is disposed in contact on the magnetic reference layer. The tunneling barrier layer is disposed in contact on the first magnetic multi-layer film. The second magnetic multi-layer film, having non-magnetic material layer, is disposed in contact on the tunneling barrier layer. The magnetic free layer is disposed in contact on the second magnetic multi-layer film, having a second magnetization direction capable of being switched to be parallel or anti-parallel to the first magnetization direction.

It is to be understood that both the foregoing general description and the following detailed description are exemplary, and are intended to provide further explanation of the embodiment as claimed.

### BRIEF DESCRIPTION OF THE DRAWINGS

The accompanying drawings are included to provide a further understanding of the embodiment, and are incorporated in and constitute a part of this specification. The drawings illustrate embodiments and, together with the description, serve to explain the principles of the embodiment.

FIG. 1 is a cross-sectional view, schematically illustrating a conventional structure of in-plane magnetoresistive device.

FIGS. 2A-2B are cross-sectional views, schematically illustrating the structures of perpendicular magnetoresistive device.

FIG. 3 is a cross-section view, schematically illustrating the reason for the in-plane MgO-MTJ with high MR, based on the magnetic layer of CoFeB.

FIG. 4 is a cross-section view, schematically the method to form illustrating perpendicular magnetoresistive device by taking CoFeB as the inserted layer.

FIG. 5 is a cross-sectional view, schematically illustrating a perpendicular magnetoresistive device, according to an embodiment.

FIG. 6 is a cross-sectional view, schematically illustrating the structure of inserted layer by magnetic multi-layer film, according to an embodiment.

FIG. 7 is a cross-sectional view, schematically illustrating the structure of inserted layer by magnetic multi-layer film, according to an embodiment.

FIG. 8 is a drawing, schematically illustrating the magnetic hysteresis loops at two directions of in-pane and perpendicular to film surface of the conventional inserted layer, according to an investigation by the embodiment.

FIG. 9 is a drawing, schematically illustrating the magnetic hysteresis loops at two directions of in-pane and perpendicular to film surface of the novel inserted layer, according to an embodiment.

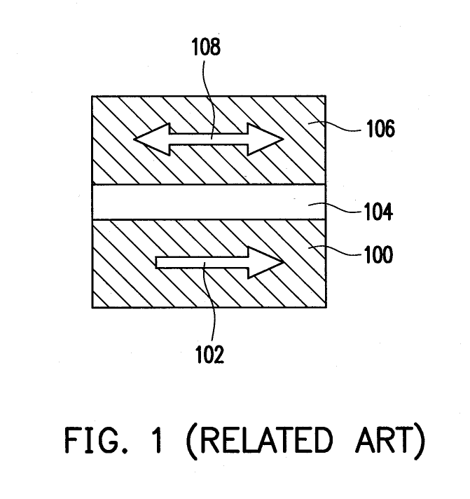

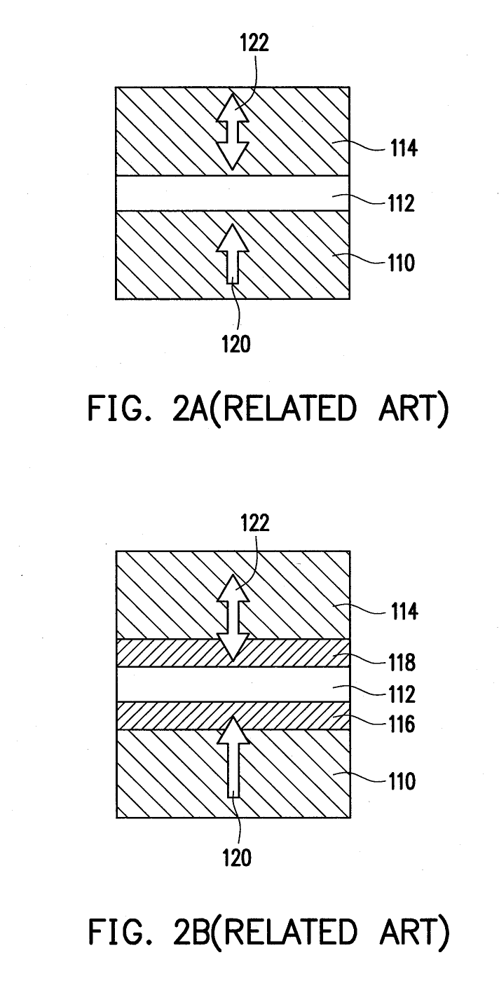

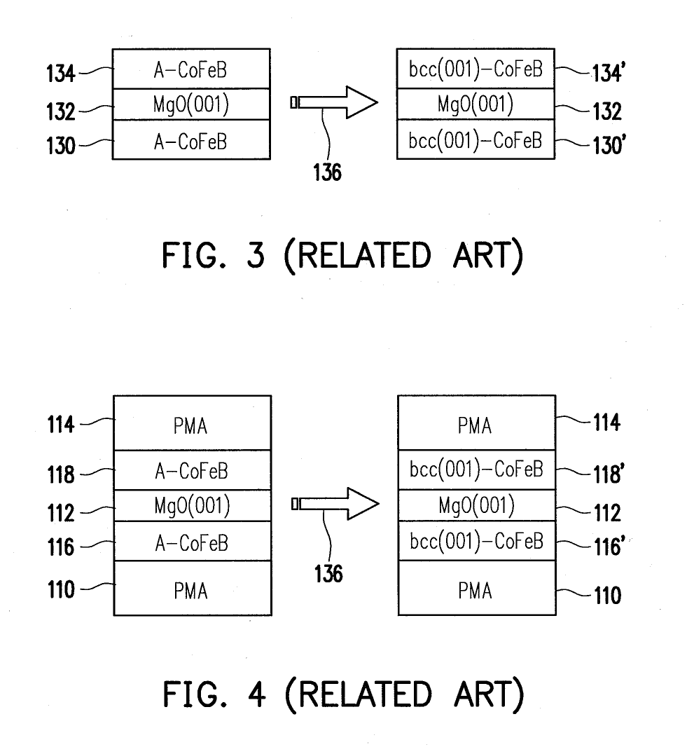

### DESCRIPTION OF THE PREFERRED EMBODIMENTS

The embodiment proposes a structure of inserted layer, applied to the perpendicular magnetoresistive device, capable of improving the MR ratio of the perpendicular magnetoresistive device.

One of embodiment proposes an inserted layer, which is formed by [ferromagnetic/non-magnetic] ([FM/NM]) multi-layer film between the PMA and MgO. Wherein, the thickness of the non-magnetic layer is rather thin, so that the coupling force still exits between the separated FM layers. In addition, the non-magnetic material can dilute the magnetization of the magnetic layer, so that the multi-layer film in general can perform as a single magnetic film with low saturation magnetization. Since the inserted layer is coupled with the adjacent PMA film, the low saturation magnetization causes weaker demagnetic effect. As a result, the magnetic moments in the multi-layer film are aligned at perpendicular direction to the film surface. By taking proper magnetic material, the multi-layer film as the inserted layer, the interface between the MgO can be the crystal structure of bcc (001) and satisfy the conditions for the MgO-MTJ with high MR.

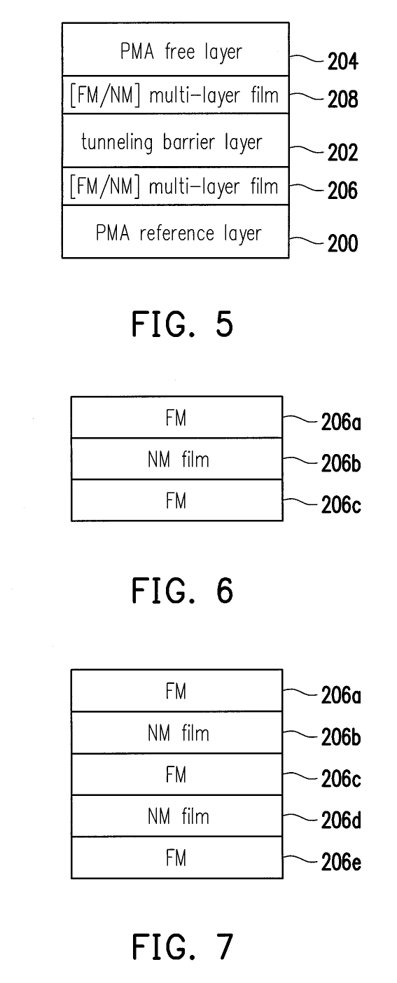

FIG. 5 is a cross-sectional view, schematically illustrating a perpendicular magnetoresistive device, according to an embodiment. In FIG. 5, the perpendicular magnetoresistive device includes a magnetic reference layer 200, also called PMA reference layer 200, a magnetic multi-layer film 206, a tunneling barrier layer 202, a magnetic multi-layer film 208, and a magnetic free layer 204, also called PMA free layer 204. The magnetic reference layer 200 is the PMA reference layer, has a fixed first magnetization direction, perpendicular to the magnetic reference layer. The magnetic multi-layer film 206 formed from FM layer and NM layer stacked alternatively as the multi-layer film is disposed in contact on the magnetic reference layer 200 and the magnetization direction is coupled with the magnetization direction of magnetic reference layer 200 to be the same. The tunneling barrier layer 202 is disposed in contact on the magnetic multi-layer film 206. The magnetic multi-layer film 208 is disposed in contact on the tunneling barrier layer 202 and has magnetization direction is coupled with the magnetization direction of magnetic free layer 204 to be the same. The magnetic free layer, as a PMA free layer, is disposed in contact on the magnetic multi-layer film 208, having a second magnetization direction perpendicular to the magnetic free layer and capable of being switched to be parallel or anti-parallel to the first magnetization direction.

In the embodiment of FIG. 5, two magnetic multi-layer films 206 and 208 are serving as the inserted layers, wherein the tunneling barrier layer 202 is MgO. For each of the magnetic multi-layer films 206 and 208, the multi-layer film is alternatively stacked from the FM layer and NM layer, for example. FIG. 6 is a cross-sectional view, schematically illustrating the structure of inserted layer by magnetic multi-layer film, according to an embodiment. In FIG. 6, the outmost two layers in the structure of magnetic multi-layer film are FM layers 206a and 206c. Depending on the number of layers to be implemented between the two layers of the FM layers 206a and 206c, the FM material and the NM material are alternatively stacked. Taking the FM layer 206 as the example, with respect to the structure of the magnetic multi-layer film with three layers, there is a non-magnetic layer 206b between the two layers of FM layers 206a and 206c.

For the better performance, the material of the FM layer 206a in contact with the tunneling barrier layer is mainly the CoFeB and the thickness is, for example, at the range of 5-20 angstroms, and preferably 10-15 angstroms. The material for the non-magnetic film 206b can be, for example, Ta, Ru, Cr, Al, Mg, Cu, Ti or Pt. The thickness of the non-magnetic film 206b can be, for example, at a range of 1-5 angstroms, and preferably 1-3 angstroms. The material of the FM layer 206c in contact with the magnetic reference layer 200 can be the FM material containing Co, such as Co, CoFe or CoFeB. However, material for the FM layer 206c can also be other FM material with similar effect, such as Fe, Ni, or NiFe. The thickness of the FM layer 206c can be 1-6 angstroms and preferably 3-5 angstroms, for example.

The magnetic multi-layer film 208 is like the structure in FIG. 6 but the FM layer 206c contacts with the magnetic free layer 204 and the FM layer 206a contacts with the tunneling barrier layer 202. In other words for example, the magnetic multi-layer film 106 and the magnetic multi-layer film 208 are symmetric to the tunneling barrier layer 202.

Further, the magnetic multi-layer film is not restricted to be just having three layers but can be more than three layers. FIG. 7 is a cross-sectional view, schematically illustrating the structure of inserted layer by magnetic multi-layer film, according to an embodiment. In FIG. 7, the magnetic multi-layer film has five layers in an example and is alternatively stacked from three FM layers 206a, 206c, 206e and two NM layers 206b, 206d. The FM layers 206a contacts the tunneling barrier layer 202 and the FM layer 206e contacts the PMA material layer. The material and thickness of the FM layer 206a can be the range as described in FIG. 6. The FM layer 206e contacts the PMA material layer with the material and thickness as described in FIG. 6.

Taking one of the embodiments to compare with a conventional structure in experiment, the invention uses the multi-layer inserted layer can be helpful to have the perpendicular alignment for the magnetic moment.

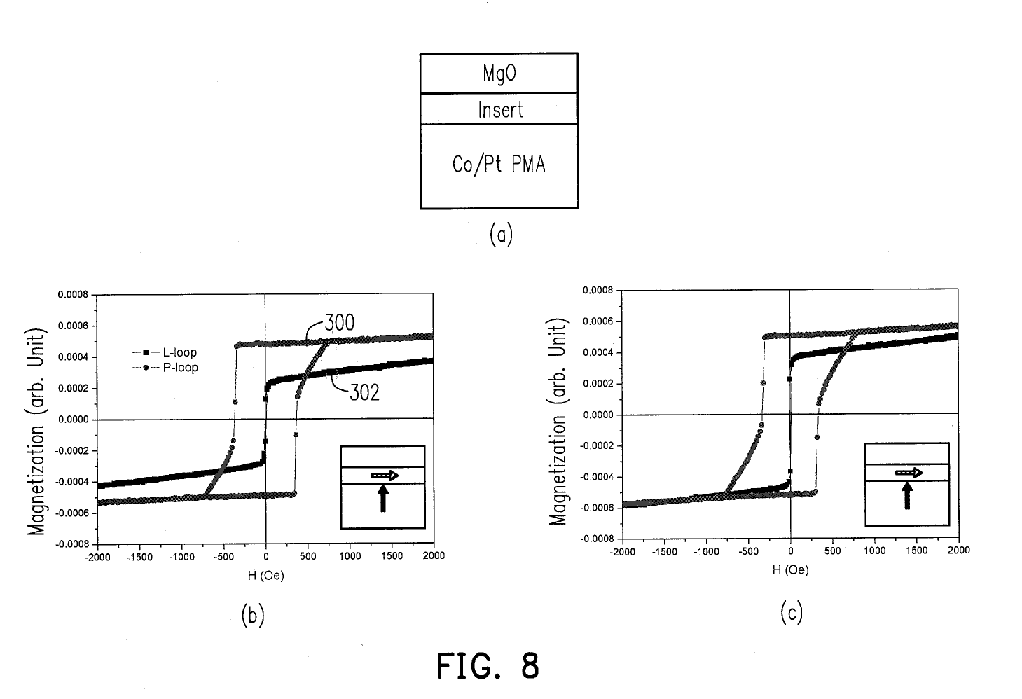

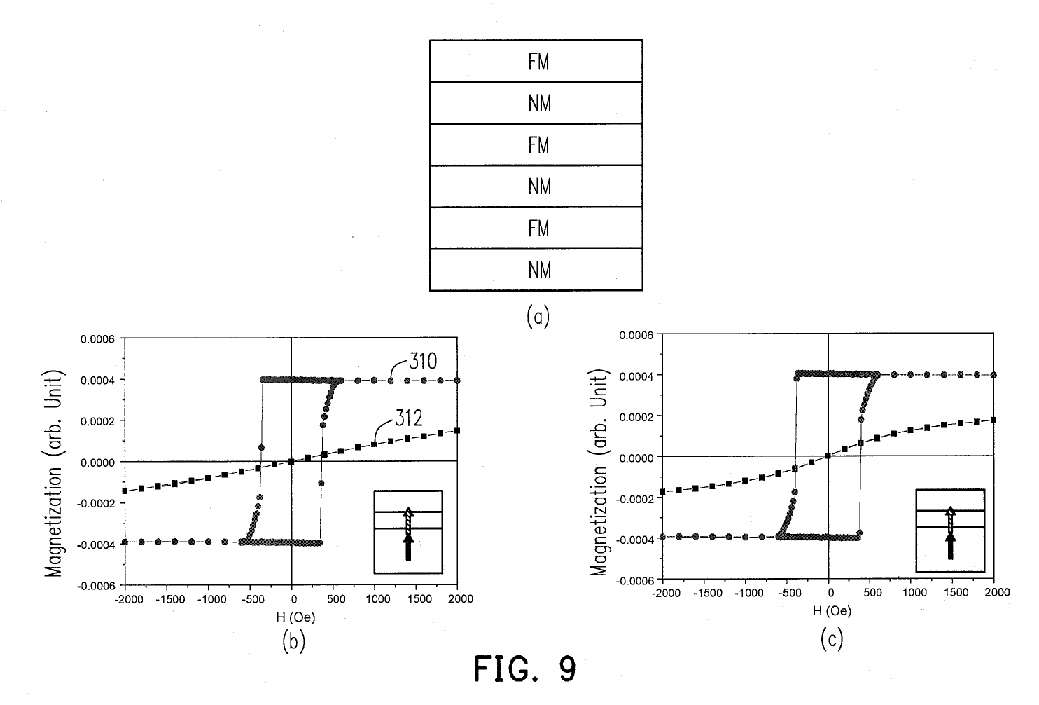

FIG. 8 is a drawing, schematically illustrating the magnetic hysteresis loops at two directions of in-pane and perpendicular to film surface of the conventional inserted layer, according to an investigation by the embodiment. The sample has been annealed at 300° C. for 2 hours before measuring the hysteresis loops. In FIG. 8(a) for the conventional FM inserted layer, the PMA layer is Co/Pt multilayer. The inserted layer is FM layer. The tunneling layer is MgO. In FIG. 8(b), the inserted layer is a single CoFeB layer with thickness of 10 angstroms, for example. The L-loop as shown in square data points is the magnetization variance at the in-plane direction while the magnetic field H is applied at the in-plane direction. The P-loop as shown in round data points is the magnetization variance at the perpendicular direction while the magnetic field H is applied at the perpendicular direction. From the data of L-loop, considerable magnetic moment can be observed at zero applied magnetic field, indicating that the inserted layer has the in-plane magnetization. In FIG. 8(c), the inserted layer is Co/CoFeB bilayer with thickness of 4 and 10 angstrom, respectively. The L-loop has also similar behavior to FIG. 8(b). The magnetization direction of the inserted layer is mainly aligned on the in-pane direction.

FIG. 9 is a drawing, schematically illustrating the magnetic hysteresis loops at two directions of in-pane and perpendicular to film surface of the novel inserted layer, according to an embodiment. The sample has been annealed at 300° C. for 2 hours before measuring the hysteresis loops. In FIG. 9(a), the inserted layer is a structure of multi-layer film with five layers in an example. In FIG. 9(b), if the inserted layer is formed by three layers in an instance, it can be stacked by Co(4A)/Ta (1.5 A)/CoFeB(10 A), for example. The L-loop data shows a crossing on the zero point, which means that there is no in-plane magnetic moment at zero applied magnetic field. In FIG. 9(c), if the inserted layer is formed by five layers in an instance, it can be stacked by Co(4 A)/Ta (1.5 A)/CoFeB(5 A)/Ta (1.5 A)/CoFeB (10 A), for example. The L-loop has also similar behavior to FIG. 9(b). The magnetization direction of the inserted layer is aligned on the out-of-pane direction.

Therefore, the inserted layer by multi-layer film structure is applied to the perpendicular magnetoresistive device and can provide the CoFeB FM layers on both sides of the MgO tunneling barrier layer. In addition, the magnetization direction of the inserted layer can be coupled with the adjacent PMA film together to have the perpendicular magnetization in alignment. Thus, the perpendicular magnetoresistive device can have high MR ratio like the conventional magnetoresistive device, and has the characteristics of perpendicular STT mechanism.

It will be apparent to those skilled in the art that various modifications and variations can be made to the structure of the embodiment without departing from the scope or spirit of the embodiment. In view of the foregoing descriptions, it is intended that the embodiment covers modifications and variations of this embodiment if they fall within the scope of the following claims and their equivalents.

What is claimed is:

1. A structure of perpendicular magnetoresistive device, comprising:
a magnetic reference layer, having a first magnetization direction, perpendicular to the magnetic reference layer;
a first magnetic multi-layer film, having a non-magnetic material layer, disposed in contact on the magnetic reference layer;
a tunneling barrier layer, disposed in contact on the first magnetic multi-layer film;
a second magnetic multi-layer film, having a non-magnetic material layer, disposed in contact on the tunneling barrier layer; and
a magnetic free layer, disposed in contact on the second magnetic multi-layer film, having a second magnetization direction capable of being switched to be parallel or anti-parallel to the first magnetization direction.

2. The structure of perpendicular magnetoresistive device of claim 1, wherein the first magnetic multi-layer film includes at least three material layers, alternatively stacked from a FM material layers and a non-magnetic material layer, wherein the FM material layer has two layers at two outmost surfaces.

3. The structure of perpendicular magnetoresistive device of claim 2, wherein a material of an inner FM layer of the first magnetic multi-layer film in contact with the tunneling barrier layer is CoFeB; and an outer FM layer in contact with the magnetic reference layer contains Co.

4. The structure of perpendicular magnetoresistive device of claim 3, wherein the inner FM layer has a thickness range of 5-20 angstroms, the outer FM layer has a thickness range of 1-6 angstroms, and the non-magnetic material layer between the inner FM layer and the outer FM layer has a thickness range of 1-5 angstroms.

5. The structure of perpendicular magnetoresistive device of claim 3, wherein the inner FM layer has a thickness range of 10-15 angstroms, the outer FM layer has a thickness range of 3-5 angstroms, and the non-magnetic layer between the inner FM layer and the outer FM layer has a thickness range of 1-3 angstroms.

6. The structure of perpendicular magnetoresistive device of claim 3, wherein a material of the non-magnetic material layer between the inner FM layer and the outer FM layer in the first magnetic multi-layer film includes Ta, Ru, Cr, Al, Mg, Cu, Ti, or Pt.

7. The structure of perpendicular magnetoresistive device of claim 1, wherein the first magnetic multi-layer film is a three-layer structure, including:
a Co-containing FM layer, on the magnetic reference layer;
a non-magnetic material layer, on the Co-containing FM layer; and
a CoFeB FM layer, on the non-magnetic material layer, contacting with the tunneling barrier layer.

8. The structure of perpendicular magnetoresistive device of claim 7, wherein a material of the non-magnetic material layer is Ta, Ru, Cr, Al, Mg, Cu, Ti, or Pt.

9. The structure of perpendicular magnetoresistive device of claim 7, wherein the CoFeB FM layer has a thickness rang of 5-20 angstroms, the non-magnetic material layer has a thickness range of 1-5 angstroms, and the Co-containing FM layer has a thickness range of 1-6 angstroms.

10. The structure of perpendicular magnetoresistive device of claim 1, wherein the second magnetic multi-layer film includes at least three material layers, alternatively stacked from a FM material layers and a non-magnetic material layer, wherein the FM material layer has two layers at two outmost surfaces.

11. The structure of perpendicular magnetoresistive device of claim 10, wherein a material of an inner FM layer of the second magnetic multi-layer film in contact with the tunneling barrier layer is CoFeB; and an outer FM layer in contact with the magnetic free layer contains Co.

12. The structure of perpendicular magnetoresistive device of claim 11, wherein the inner FM layer has a thickness range of 5-20 angstroms, the outer FM layer has a thickness range of 1-6 angstroms, and the non-magnetic material layer between the inner FM layer and the outer FM layer has a thickness range of 1-5 angstroms.

13. The structure of perpendicular magnetoresistive device of claim 11, wherein the inner FM layer has a thickness range of 10-15 angstroms, the outer FM layer has a thickness range of 3-5 angstroms, and the non-magnetic material layer between the inner FM layer and the outer FM layer has a thickness range of 1-3 angstroms.

14. The structure of perpendicular magnetoresistive device of claim 11, wherein a material of the non-magnetic material layer between the inner FM layer and the outer FM layer in the second magnetic multi-layer film is Ta, Ru, Cr, Al, Mg, Cu, Ti, or Pt.

15. The structure of perpendicular magnetoresistive device of claim 1, wherein the second magnetic multi-layer film is a three-layer structure, including:
a Co-containing FM layer, under the magnetic free layer;
a non-magnetic material layer, under the Co-containing FM layer; and
a CoFeB FM layer, under the non-magnetic material layer, contacting with the tunneling barrier layer.

16. The structure of perpendicular magnetoresistive device of claim 15, wherein a material of the non-magnetic material layer is Ta, Ru, Cr, Al, Mg, Cu, Ti, or Pt.

17. The structure of perpendicular magnetoresistive device of claim 15, wherein the CoFeB FM layer has a thickness rang of 5-20 angstroms, the non-magnetic material layer has a thickness range of 1-5 angstroms, and the Co-containing FM layer has a thickness range of 1-6 angstroms.

18. The structure of perpendicular magnetoresistive device of claim 1, wherein both the first magnetic multi-layer film and the second magnetic multi-layer film are a structure of at least three layers symmetric to the tunneling barrier layer, and are alternatively stacked from a FM material layer and a non-magnetic material layer, the FM material layer has two layers on two outmost surface.

19. The structure of perpendicular magnetoresistive device of claim 18, wherein an inner is defined to be toward the tunneling barrier layer, each of the first magnetic multi-layer film and the second magnetic multi-layer film includes:
a CoFeB FM layer, contacting with the tunneling barrier layer;
a Co-containing FM layer, on outer of the CoFeB FM layer; and
a non-magnetic material layer, between the Co-containing FM layer and the CoFeB FM layer.

20. The structure of perpendicular magnetoresistive device of claim 19, wherein the CoFeB FM layer has a thickness range of 5-20 angstroms, the non-magnetic material layer has a thickness range of 1-5 angstroms, and the Co-containing FM layer has a thickness range of 1-6 angstroms.
